(19) United States
(12) Patent Application Publication
(10) Pub. No.: US 2026/0244469 A1
(43) Pub. Date: Aug. 20, 2026

(54) METHOD AND SYSTEM FOR AUTOMATIC GUIDE AND CLIENT APPARATUS

(71) Applicant: King One Interactive Technology Co., Ltd., Taipei City (TW)

(72) Inventors: Shih-Chi Wang, Taipei City (TW); Yu-Chou Lai, Taipei City (TW)

(73) Assignee: King One Interactive Technology Co., Ltd., Taipei City (TW)

(21) Appl. No.: 19/079,386

(22) Filed: Mar. 13, 2025

(30) Foreign Application Priority Data
Feb. 14, 2025 (TW) 114105631

(51) Int. Cl. G06F 9/451; G06F 3/04815; G06F 3/04842

(52) U.S. Cl. CPC G06F 9/453; G06F 3/04815; G06F 3/04842

(57) ABSTRACT

Provided are a method and a system for automatic guide and a client apparatus. The method for automatic guide includes: after displaying a three-dimensional space model, obtaining response content corresponding to an input message; when the response content includes a description associated with a virtual object in the three-dimensional space model, displaying the response content and a recommended option corresponding to the virtual object; and when selecting the recommended option, automatically guiding a viewing angle of a user to a suitable angle.

### CROSS-REFERENCE TO RELATED APPLICATION

This application claims the priority benefit of Taiwan application serial no. 114105631 filed on Feb. 14, 2025. The entirety of the above-mentioned patent application is hereby incorporated by reference herein and made a part of this specification.

### BACKGROUND

### Technical Field

The invention relates to a technology for establishing a virtual space, and particularly relates to a method and a system for automatic guide and a client apparatus for a three-dimensional space model.

### Description of Related Art

Along with advancement of technology and rise of the Internet, more and more websites are available for people to obtain information they need through Internet connections. In an era of innovation and change, a conventional way of browsing photos and reading text is increasingly unable to meet the needs of the public. Therefore, a three-dimensional guide technology is developed, which creates a simulated environment to make users feel as if they are in the scene, and automatic guide is currently one of directions to be studied.

### SUMMARY

The invention is directed to a method and a system for automatic guide, and a client apparatus that combines artificial intelligence (AI) technology to enable users to quickly access information of interest.

The invention provides a method for automatic guide, which is adapted to an automatic guide system including a client apparatus and a cloud server, the method for automatic guide includes: communicatively connecting the cloud server through a user interface of the client apparatus, and displaying a three-dimensional space model provided by the cloud server in the user interface, wherein the three-dimensional space model has space layout data; receiving an input message through an input device of the client apparatus, and transmitting the input message to the cloud server through the user interface; obtaining response content corresponding to the input message from the space layout data through the cloud server; when the response content includes a description associated with a virtual object in the three-dimensional space model, outputting the response content and a recommended option associated with the virtual object to the user interface for display through the cloud server; when the recommended option is selected through the user interface, automatically sending a control instruction to the cloud server through the user interface, so that the cloud server drives a virtual camera corresponding to the three-dimensional space model to move to a specified positioning point corresponding to the virtual object, and executing a real-time rendering program to embed a specified panoramic image corresponding to the specified positioning point as a material to the three-dimensional space model; and displaying the three-dimensional space model embedded with the specified panoramic image through the user interface.

In an embodiment of the invention, the three-dimensional space model includes a plurality of positioning points, and a database of the cloud server includes a plurality of panoramic images respectively corresponding to the plurality of positioning points, the specified positioning point is one of the positioning points, and the specified panoramic image is one of the panoramic images.

In an embodiment of the invention, the method for automatic guide further includes: providing a space layout interface through a cloud server; and setting a layout of a virtual space corresponding to the three-dimensional space model through the space layout interface to obtain the space layout data.

In an embodiment of the invention, the space layout data includes a plurality of virtual objects corresponding to a plurality of exhibits, and each of the virtual objects has a corresponding configuration position and a positioning point.

In an embodiment of the invention, the method for automatic guide further includes: in response to the user interface of the client apparatus communicatively connecting the cloud server, executing a real-time rendering program through the cloud server to embed a preset panoramic image corresponding to a preset position as a material to the three-dimensional space model; and displaying the three-dimensional space model embedded with the preset panoramic image through the user interface. The three-dimensional space model includes a plurality of positioning points, and a database of the cloud server includes a plurality of panoramic images respectively corresponding to the plurality of positioning points, the preset position is one of the positioning points, and the preset panoramic image is one of the panoramic images.

In an embodiment of the invention, the step of obtaining the response content corresponding to the input message from the space layout data through the cloud server includes: querying the space layout data of the three-dimensional space model through a large language model provided by the cloud server to obtain a query result corresponding to the input message; and using the large language model by the cloud server to convert the query result into the response content conforming to a prompt engineering.

In an embodiment of the invention, when the response content includes the description associated with the virtual object in the three-dimensional space model, the method includes: generating the recommended option associated with the virtual object through a front-end program provided by the cloud server, and outputting the response content and the recommended option to the user interface.

The invention provides an automatic guide system including a cloud server and a client apparatus, wherein the client apparatus includes a first storage device having a user interface, an input device and a first processor, and the cloud server includes a second processor. In the client apparatus, the first processor is configured to: communicatively connecting the cloud server through the user interface of the client apparatus, and displaying a three-dimensional space model provided by the cloud server in the user interface, wherein the three-dimensional space model has space layout data; receiving an input message through the input device, and transmitting the input message to the cloud server through the user interface. In the cloud server, the second processor is configured to: obtaining response content corresponding to the input message from the space layout data, determining whether the response content includes a description associated with a virtual object in the three-dimensional space model, and outputting the response content and a recommended option associated with the virtual object to the user interface for display through the cloud server when the response content includes the description associated with the virtual object in the three-dimensional space model. In the client apparatus, the first processor is configured to: when the recommended option is selected through the user interface, automatically sending a control instruction to the cloud server through the user interface. In the cloud server, the second processor is configured to: in response to receiving the control instruction, moving a virtual camera corresponding to the three-dimensional space model to a specified positioning point corresponding to the virtual object, and executing a real-time rendering program to embed a specified panoramic image corresponding to the specified positioning point as a material to the three-dimensional space model; and displaying the three-dimensional space model embedded with the specified panoramic image through the user interface.

The invention provides a method for automatic guide, which uses a processor to execute following steps: displaying a three-dimensional space model through a user interface, wherein the three-dimensional space model has space layout data; receiving input message through an input device; obtaining response content corresponding to the input message through the user interface, wherein the response content is generated based on the space layout data; when the response content includes a description associated with a virtual object in the three-dimensional space model, displaying the response content and a recommended option corresponding to the virtual object in the user interface; when the recommended option is selected through the user interface, driving a virtual camera corresponding to the three-dimensional space model to move to a specified positioning point corresponding to the virtual object through the user interface, and executing a real-time rendering program to embed a specified panoramic image corresponding to the specified positioning point as a material to the three-dimensional space model; and displaying the three-dimensional space model embedded with the specified panoramic image through the user interface.

The invention provides a client apparatus, which includes a storage device including a user interface; an input device; and a processor coupled to the storage device and the input device and configured to execute each step of the above-mentioned method for automatic guide.

Based on the above descriptions, the invention combines artificial intelligence to implement a function of automatic guide, which may actively provide guide based on the content that the user is interested in. The guide may be automatically implemented without requiring a user to click, thereby achieving rapid deployment of virtual exhibition and intelligent customer service and guide function.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an automatic guide system according to an embodiment of the invention.

FIG. 2 is a flowchart of a method for automatic guide according to an embodiment of the invention.

FIG. 3 is a schematic diagram of a three-dimensional space model including a plurality of positioning points according to an embodiment of the invention.

FIGS. 4A to 4D are schematic diagrams showing an operation of a space layout interface according to an embodiment of the invention.

FIG. 5 is a flowchart of executing an automatic guide system according to an embodiment of the invention.

### DESCRIPTION OF THE EMBODIMENTS

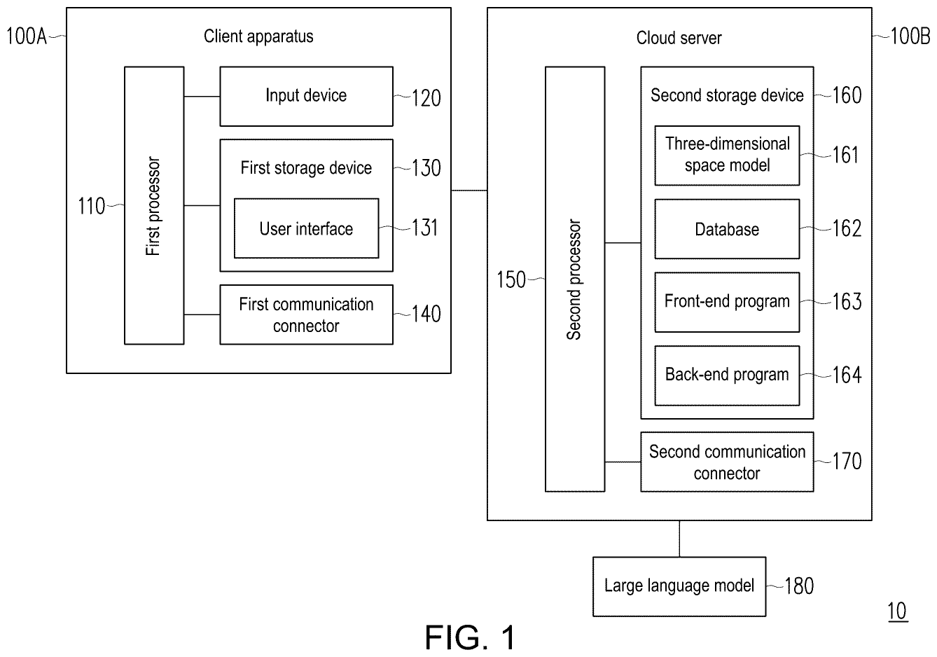

FIG. 1 is a block diagram of an automatic guide system according to an embodiment of the invention. Referring to FIG. 1, an automatic guide system 10 includes a client apparatus 100A and a cloud server 100B. The client apparatus 100A is, for example, an electronic apparatus such as a smart phone, a tablet computer, a notebook computer, or a desktop computer that is used by a user. The cloud server 100B is, for example, a computer with a powerful computing capability or a large amount of disk storage space. The client apparatus 100A and the cloud server 100B may be connected by using a wired or wireless communication technology.

The client apparatus 100A includes a first processor 110, an input device 120, a first storage device 130 and a first communication connector 140. The first processor 110 is coupled to the input device 120, the first storage device 130, and the first communication connector 140. The first storage device 130 stores at least one program instruction, and the first processor 110 executes the at least one program instruction to implement subsequent steps of automatic guide.

In the client apparatus 100A, the first storage device 130 includes a user interface 131. In an embodiment, the user interface 131 is a browser. In another embodiment, the user interface 131 is a graphical interface provided by an application (APP).

The cloud server 100B includes a second processor 150, a second storage device 160 and a second communication connector 170. The second storage device 160 stores at least one program instruction, and the second processor 150 executes the at least one program instruction to implement subsequent steps pf automatic guide.

In the cloud server 100B, the second storage device 160 includes a three-dimensional space model 161, a database 162, a front-end program 163, and a back-end program 164. In an embodiment, the front-end program 163 and the back-end program 164 respectively include one or a plurality of program instructions, and after being installed, the program instructions are executed by the second processor 150. The front-end program 163 is used for providing content to the user interface 131 of the client apparatus 100A. The back-end program 164 may be used by a developer (administrator) to develop, manage and/or edit the three-dimensional space model 161.

The database 162 stores a plurality of panoramic images corresponding to a plurality of positioning points included in the three-dimensional space model 161 and a task script corresponding to the three-dimensional space model 161. The panoramic images may be created, for example, by using three-dimensional animation software, or may be obtained through shooting by using a camera. A virtual camera of the three-dimensional animation software may simulate a real-world camera, divide a three-dimensional scene into photos of multiple angles, and then post-process this group of photos into a panoramic image. The task script is a set of events designed for a specific task. For example, the specific task may be one of the following: website page guide, space automatic walking, website visual explanation, line of sight guidance, voice explanation, model explanation from various angles, etc.

The automatic guide system 10 further includes a large language model (LLM) 180. The large language model 180 may be set in another server different from the cloud server 100B. Alternatively, the large language model 180 may also be set in the cloud server 100B, which is not limited by the invention. The large language model 180 is an artificial intelligence (AI) program, which is built based on machine learning and may recognize and interpret human language or other types of complex data to generate text and complete other tasks. The large language model 180 is composed of an artificial neural network with many parameters, which is trained on a large amount of text data by using self-supervised learning or semi-supervised learning. For example, the large language model 180 may be ChatGPT, GPT4, LLaMA-65B, PaLM-62B, BERT, T5, ERNIE Bot, etc.

The first processor 110 and the second processor 150 are, for example, central processing units (CPUs), graphics processing units (GPUs), or other programmable microprocessors, digital signal processors (DSPs), programmable controllers, application specific integrated circuits (ASICs), programmable logic devices (PLDs) or other similar devices.

The first storage device 130 and the second storage device 160 are, for example, any type of fixed or removable random access memory, read-only memory, flash memory, hard disk or other similar devices or a combination of these devices.

The first communication connector 140 and the second communication connector 170 may be chips or circuits that adopt local area network (LAN) technology, wireless local area network (WLAN) technology or mobile communication technology. The local area network is, for example, Ethernet. The wireless local area network is, for example, Wi-Fi. The mobile communication technology is, for example, global system for mobile communications (GSM), a third-generation mobile communication technology (3G), a fourth-generation mobile communication technology (4G), a fifth-generation mobile communication technology (5G), etc.

The input device 120 is, for example, a mouse, a keyboard, a touch screen, a voice sensor, etc. The voice sensor is, for example, a microphone array audio in module, which is used to collect sounds at a scene to generate corresponding voice signals accordingly.

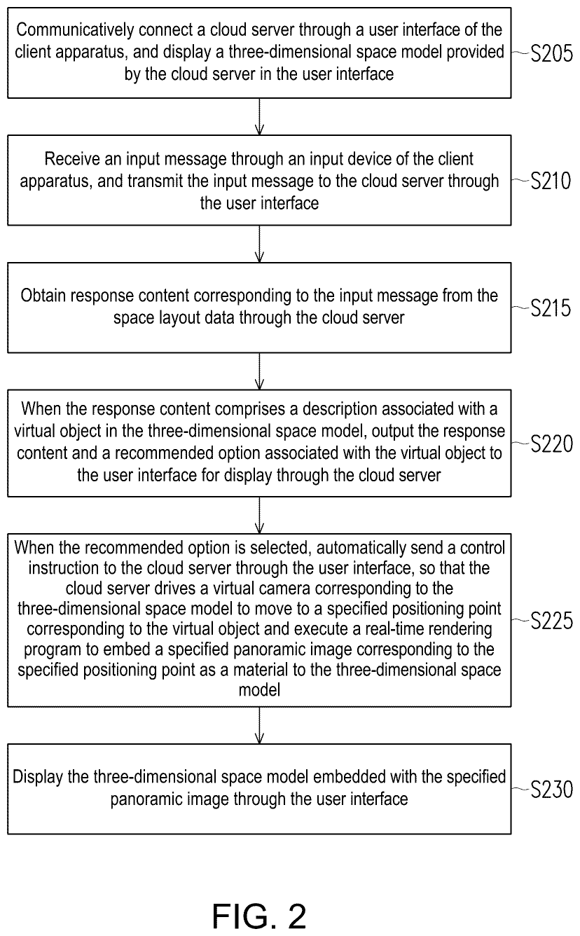

FIG. 2 is a flowchart of a method for automatic guide according to an embodiment of the invention. Referring to FIG. 1 and FIG. 2, in step S205, the user interface 131 of the client apparatus 100A is communicatively connected to the cloud server 100B, and the three-dimensional space model 161 provided by the cloud server 100B is displayed in the user interface 131. Here, the three-dimensional space model 161 has space layout data. For example, if the user interface 131 is a browser, a user may enter a specified URL in the browser of the client apparatus 100A to connect to the cloud server 100B, and the browser may display the three-dimensional space model 161 provided by the cloud server 100B. If the user interface 131 is an application, the user may execute the application in the client apparatus 100A, and the application automatically connects to the cloud server 100B based on its internal setting parameters, and displays the three-dimensional space model 161 provided by the cloud server 100B in an interface of the application.

In response to the communication connection between the user interface 131 of the client device 100A and the cloud server 100B, the cloud server 100B executes a real-time rendering program to embed a preset panoramic image corresponding to a preset position as a material to the three-dimensional space model 161. Furthermore, the user interface 131 displays the three-dimensional space model 161 embedded with the preset panoramic image. Generally, a three-dimensional model is covered with a texture, and a process of arranging the texture onto the three-dimensional model is referred to as texture mapping. After the texture mapping, the three-dimensional model may be made more detailed and look more realistic. In the embodiment, the panoramic image is used as a material of texture mapping and is embedded into the three-dimensional space model 161. In addition to texture mapping, normals of curved surfaces may be adjusted to achieve an illumination effect, and some curved surfaces may also adopt bump texture mapping and other stereo rendering techniques.

During the rendering process, the second processor 150 uses a virtual camera to locate a relationship between the virtual objects in the three-dimensional space model 161 through the front-end program 163, thereby obtaining a plurality of rendering parameters. In the real world, due to reflection of light from an object to the eyes, the eyes may see the object. A location of the virtual camera is a location of the “eye”. A rendering parameter such as a corresponding reflection index between the virtual camera and each pixel in the stereoscopic space model 161 may be calculated through ray tracing. Therefore, after obtaining a specified positioning point (a moving destination of the virtual camera), the second processor 150 may further move the virtual camera to the specified positioning point to obtain a rendering parameter corresponding to the specified positioning point.

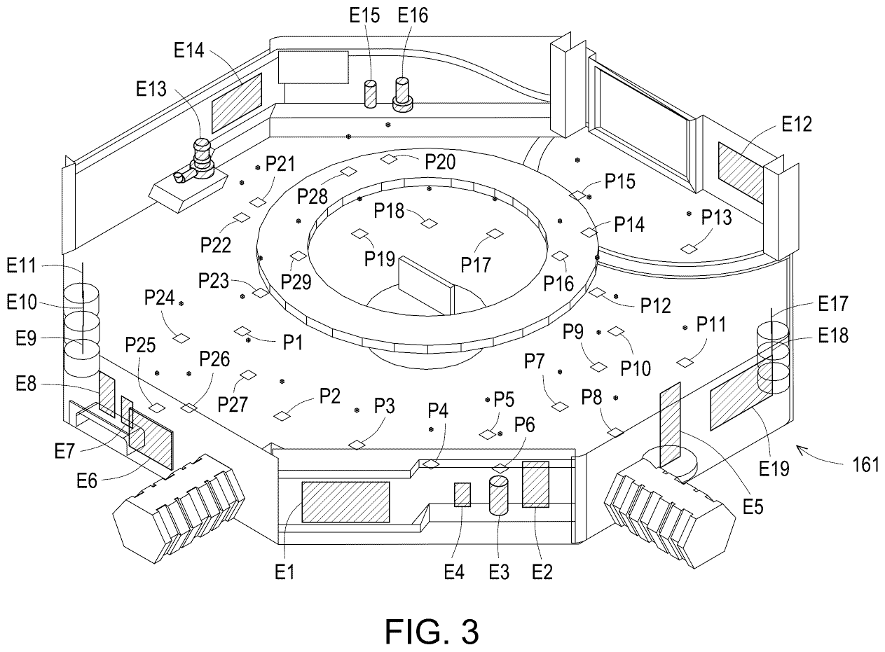

FIG. 3 is a schematic diagram of a three-dimensional space model including a plurality of positioning points according to an embodiment of the invention. Referring to FIG. 3, the three-dimensional space model 161 is, for example, a three-dimensional space model corresponding to a virtual space generated by a three-dimensional model designer by using a three-dimensional modeling tool or other software according to customer requirements. After generating the three-dimensional space model 161, the three-dimensional model designer sets a plurality of positioning points P1 to P29 in the three-dimensional space model 161 according to customer requirements, and sets a corresponding panoramic image for each of the positioning points P1 to P29 and stores the same in the database 162. In addition, at least one interactive position may be reserved in advance in the three-dimensional space model 161 according to actual needs, so that the user may dynamically arrange an interactive element. The interactive element is, for example, a multimedia file, an interactive interface or a button. In the embodiment shown in FIG. 3, the three-dimensional space model 161 is pre-set with 19 interactive positions E1-E19. However, this is only an example and the number of the positioning points and the number of the reserved interactive positions are not limited by the invention.

The client apparatus 100A is, for example, connected to the cloud server 100B to open a three-dimensional webpage. After receiving a connection notification, the cloud server 100B may activate the three-dimensional space model 161. In the cloud server 100B, the second processor 150 executes tasks through the front-end program 163 according to preset task scripts, interactive operations, etc.

After executing the three-dimensional space model 161 and before detecting an operation instruction functioning on the three-dimensional space model 161, the second processor 150 first moves a lens position of the virtual camera to a preset position (such as the positioning point P1, but the invention is not limited thereto) through the front-end program 163, and executes a real-time rendering program to embed a panoramic image (the preset panoramic image) corresponding to the positioning point P1 as a material to the three-dimensional space model 161, so that a display screen of the user interface 131 of the client apparatus 100A presents the three-dimensional space model 161 embedded with the preset panoramic image.

Then, in step S210, an input message is received through the input device 120 of the client apparatus 100A, and is sent to the cloud server 100B through the user interface 131. Then, in step S215, response content corresponding to the input message is obtained from the space layout data through the cloud server 100B.

For example, the input device 120 is a voice sensor, and a voice of the user is received through the input device 120 to generate a voice signal (input message), and the voice signal is transmitted to the cloud server 100B through the connection between the client apparatus 100A and the cloud server 100B by using the user interface 130. In the cloud server 100B, the second processor 150 analyzes the voice signal through the front-end program 163 to obtain the input message, and obtains the response content corresponding to the input message from the space layout data.

In an embodiment, the space layout data may be generated, for example, through the back-end program 164. The back-end program 164 provides a space layout interface, through which a layout of the virtual space corresponding to the three-dimensional space model 161 is set, thereby obtaining the space layout data. The space layout data includes a plurality of virtual objects corresponding to a plurality of exhibits, and each virtual object has a corresponding configuration position and a positioning point.

For example, the developer may use a browser in the client apparatus 100A or an electronic device similar to the client apparatus 100A (or an application developed corresponding to the cloud server 100B) to connect to the cloud server 100B, and then arrange the layout of the virtual space corresponding to the three-dimensional space model 161 through the back-end program 164. For example, the space layout interface provided by the back-end program 164 guides the developer to set images and videos used for the virtual space (similar to an act of posting posters in a physical space), a plurality of virtual objects corresponding to a plurality of exhibits, and data for display windows (content of windows that expand after clicking).

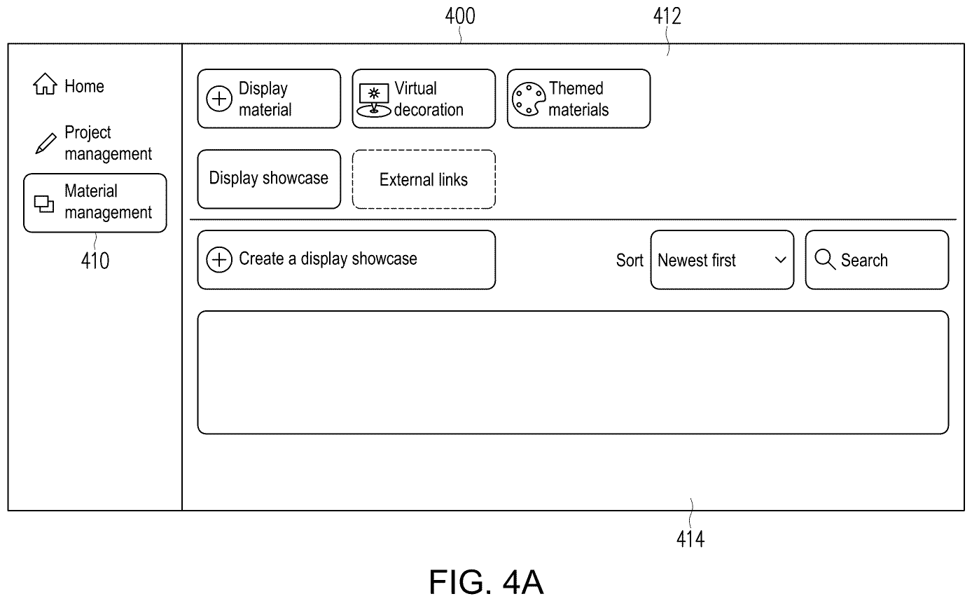

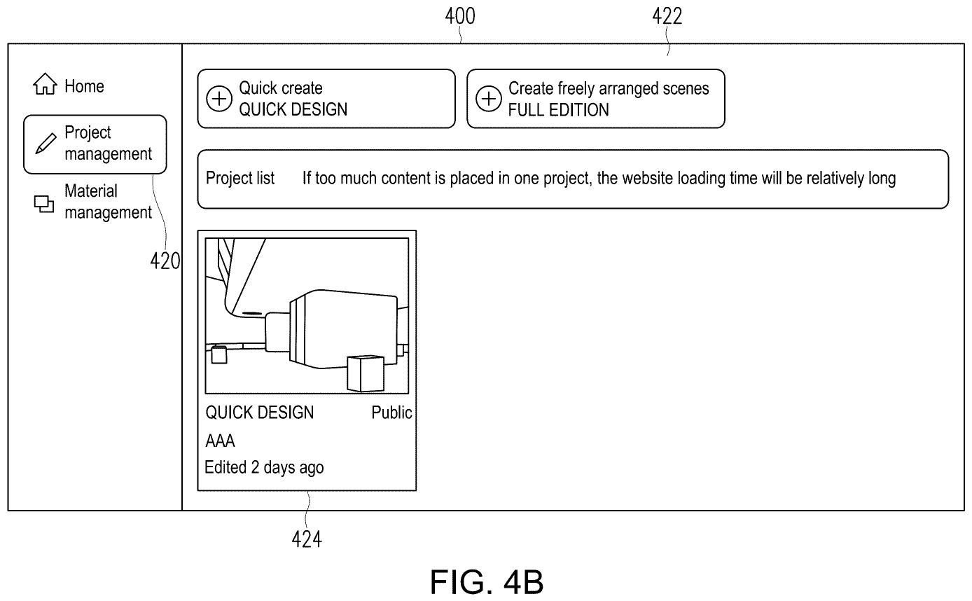

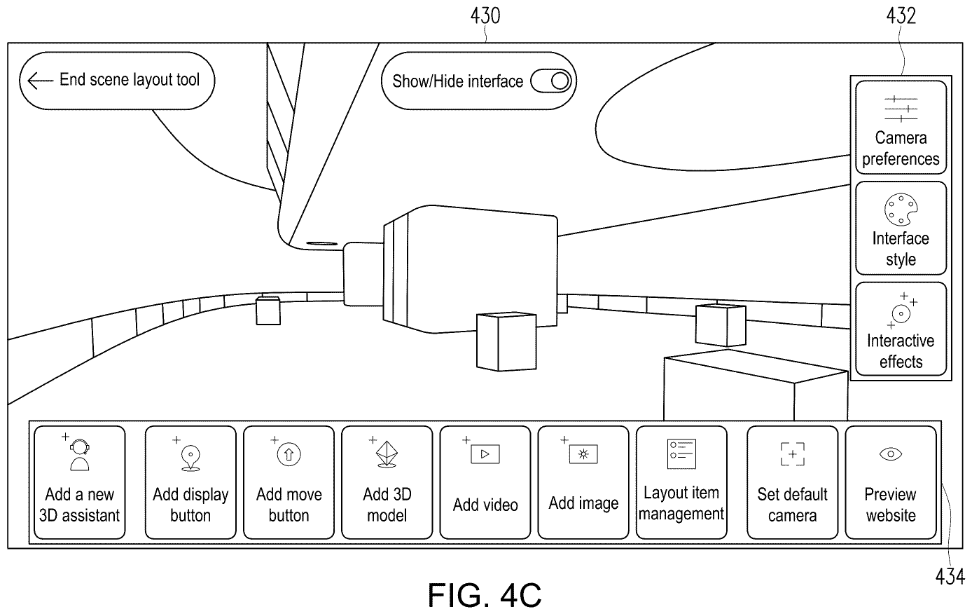

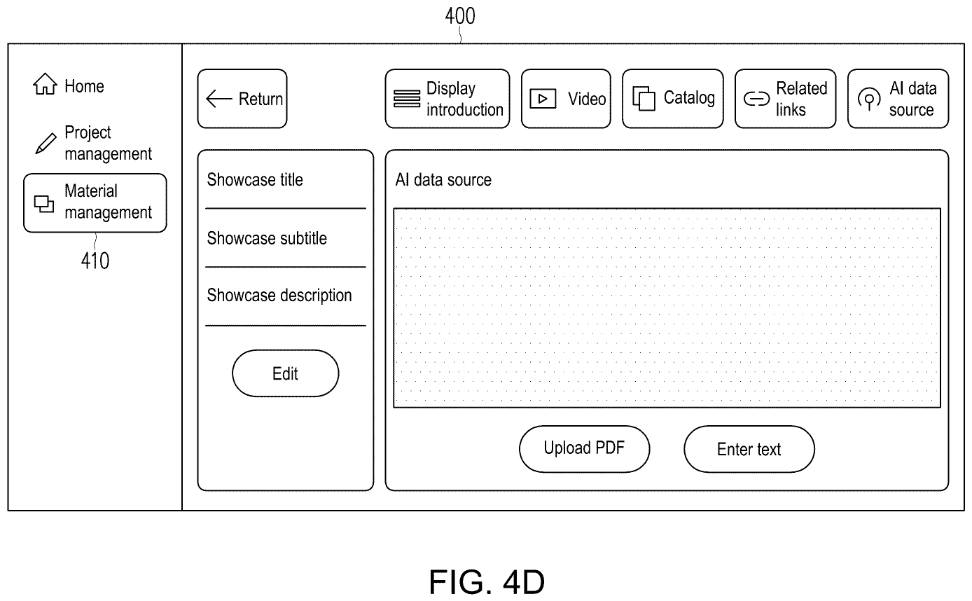

FIGS. 4A to 4D are schematic diagrams showing an operation of a space layout interface according to an embodiment of the invention. First, in FIG. 4A, the developer selects an option 410 of a space layout interface 400, and then the developer is guided in a block 412 to prepare and set images, videos used for the virtual space, and data for display showcase. For example, the block 412 provides functional options such as “display material”, “virtual decoration”, “theme material”, “display showcase”, “external link”, etc., for the developer to use, and displays a selected result in a block 414.

In FIG. 4B, the developer selects an option 420 of the space layout interface 400, and creates a new project (for space layout) in a block 422 through functional options such as “quick create” or “create a freely edited scene”, or selects a created project 424 in a created project list for management or browsing.

After selecting a project (a new project or the created project 424), a layout management page 430 shown in FIG. 4C is entered. The layout management page 430 provides tool lists 432 and 434 (including a plurality of editing tools) for the developer to layout previously prepared data in the virtual space. After the data is arranged in the virtual space, the back-end program 164 may bind the virtual objects (exhibits, functional showcases) arranged in the virtual space and spatial information (such as configuration positions) thereof to the virtual space, thereby generating the space layout data.

In addition, as the developer completes the space layout, the space layout interface 400 may further guide the developer to add more information about the exhibits and an exhibition room, as shown in FIG. 4D. Accordingly, through the guidance of the space layout interface 400, the developer may further supplement sufficient relevant information while focusing on arranging the virtual space.

After completing the layout of the virtual space, the back-end program 164 may automatically generate a knowledge base based on the space layout data of the virtual space, and its purpose is to convert the space layout data into vector data and store the same in a vector database to facilitate subsequent data search and use of the large language model 180.

The space layout interface 400 uses previously bound attributes (each laid out virtual object has attributes belonging to the virtual space) to separate the data of the virtual space. In other words, when searching for data subsequently, the large language model 180 will only search a vector database for the space layout data set for the corresponding virtual space, which may avoid mutual contamination of data between different virtual spaces to avoid AI hallucinations (errors or misleading results generated by an AI model).

After obtaining the response content corresponding to the input message, in step S220, when the response content includes a description associated with the virtual object in the three-dimensional space model 161, the response content and a recommended option associated with the virtual object are output to the user interface 131 for display through the cloud server 100B.

The large language model 180 analyzes the input message in real time and infers whether user's preferences are related to the virtual objects arranged in the three-dimensional space model 161. If it is analyzed that the virtual objects arranged in the three-dimensional space model 161 meet the user's preferences, the front-end program 163 may generate a recommended option and output the same to the user interface 131 for display. In an embodiment, the recommended option may be presented in a “button” manner. In addition, if it is determined that there are descriptions associated with a plurality of virtual components in the response content, a plurality of recommended options for the plurality of virtual components may be generated respectively.

Then, in step S225, when a recommended option is selected through the user interface 131, a control instruction is automatically sent to the cloud server 100B through the user interface 131, so that the cloud server 100B drives the virtual camera corresponding to the three-dimensional space model 161 to move to a specified positioning point corresponding to the virtual object, and executes a real-time rendering program to embed a specified panoramic image corresponding to the specified positioning point as a material to the three-dimensional space model 161.

Then, in step S230, the three-dimensional space model 161 embedded with the specified panoramic image is displayed through the user interface 131. Namely, in actual application, when the user wants to view the recommended option, the user may manually touch the recommended option in the user interface 131 (the user interface 131 automatically generates a control instruction after detecting a touch operation), or use voice control to issue the control instruction for selecting the recommended option. Then, the user interface 131 sends the control instruction to the cloud server 100B, and the front-end program 163 analyzes location information of the recommended option in the virtual space, thereby guiding a user's viewing angle to a suitable viewing angle. That is, the virtual camera is moved to the specified positioning point corresponding to the virtual object bound to the recommended option, and the real-time rendering program is executed to embed the specified panoramic image corresponding to the specified positioning point as a material to the three-dimensional space model 161.

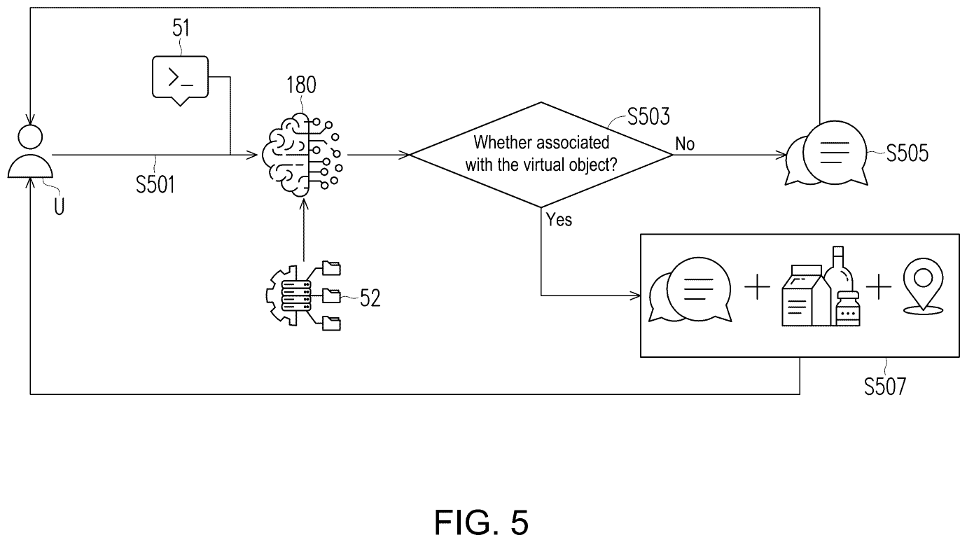

FIG. 5 is a flowchart of executing an automatic guide system according to an embodiment of the invention. Referring to FIG. 5, when the three-dimensional space model 161 is displayed through the user interface 131 of the client apparatus 100A, in step S501, a user U may perform voice input through, for example, a voice sensor (the input device 120) to accordingly generate a corresponding voice signal.

The large language model 180 provided by the cloud server 100B is used to query space layout data 52 of the three-dimensional space model 161 to obtain a query result corresponding to the input message, and the cloud server 100B uses the large language model 180 to convert the query result into the response content conforming to a prompt engineering 51.

This stage has two key functions: the prompt engineering and retrieval-augmented generation (RAG). A main focus of the prompt engineering 51 is to develop a universal prompt that gives the large language model 180 a personality similar to that of a businessperson or a tour guide, and adjust to obtain the large language model 180 that may be applied to different types of virtual spaces. In addition, in this application scenario, in order to allow the large language model 180 to provide effective and real data, a scope of data that the large language model 180 may access is narrowed in RAG, so as to develop a suitable response method. For example, the user U asks “Do you have any monitoring-related products?” (input message). The large language model 180 outputs corresponding response content according to the space layout data 52.

After the response content is obtained, in step S503, the large language model 180 is used to determine whether the response content includes a description associated with the virtual object in the three-dimensional space model 161. If the response content does not include the description associated with the virtual object in the three-dimensional space model 161, in step S505, the response content is directly output to the user interface 131 for display. If the response content includes the description associated with the virtual object in the three-dimensional space model 161, in step S507, recommended options associated with the virtual object are generated through the front-end program 163, and a configuration position corresponding to the virtual position is obtained. Thereafter, the response content, the recommended options and the configuration position are associated and output to the user interface 131.

During the conversation between the user visiting the three-dimensional space model 161 through the user interface 131 and the large language model 180, the large language model 180 is used to analyse a conversation process in real time to infer whether user's preferences are related to exhibits (virtual objects) in the three-dimensional space model 161. If it is analyzed that there are exhibits in the three-dimensional space model 161 that meet the user's preferences, the front-end program 163 generates the recommended options. For example, another window pops up on the three-dimensional space model 161 and the recommended options are provided in the window for the user to select. If the user selects one of the recommended options, the front-end program 163 may analyze coordinates of the virtual object corresponding to the recommended option in the virtual space and guide a user's viewing angle to a suitable viewing angle.

In summary, the invention combines artificial intelligence to implement a function of automatic guide, which may actively provide guide based on the content that the user is interested in, thereby creating rapid deployment of virtual displays and functions of intelligent customer service and guide. The large language model is used to perform recommendation analysis on the input message, and spatial coordinates and movement behavior of the recommended options are calculated to achieve the effect of automatic guide. The invention may achieve the effect of a smart customer service with a virtual space guide function. Compared to existing generative AI models that are prone to possibility of AI hallucinations, difficult to build, cumbersome training processes, and limited to a two-dimensional experience, the invention enables generative AI models to query space layout data in three-dimensional space models, which further breaks through the current mode of two-dimensional experience.

What is claimed is:

1. A method for automatic guide adapted to an automatic guide system, wherein the automatic guide system comprises a client apparatus and a cloud server, and the method for automatic guide comprises:
communicatively connecting the cloud server through a user interface of the client apparatus, and displaying a three-dimensional space model provided by the cloud server in the user interface, wherein the three-dimensional space model has space layout data;
receiving an input message through an input device of the client apparatus, and transmitting the input message to the cloud server through the user interface;
obtaining response content corresponding to the input message from the space layout data through the cloud server;
when the response content comprises a description associated with a virtual object in the three-dimensional space model, outputting the response content and a recommended option associated with the virtual object to the user interface for display through the cloud server;
when the recommended option is selected through the user interface, automatically sending a control instruction to the cloud server through the user interface so that the cloud server drives a virtual camera corresponding to the three-dimensional space model to move to a specified positioning point corresponding to the virtual object and execute a real-time rendering program to embed a specified panoramic image corresponding to the specified positioning point as a material to the three-dimensional space model; and
displaying the three-dimensional space model embedded with the specified panoramic image through the user interface.

2. The method for automatic guide as claimed in claim 1, wherein the three-dimensional space model comprises a plurality of positioning points, a database of the cloud server comprises a plurality of panoramic images respectively corresponding to the plurality of positioning points, the specified positioning point is one of the positioning points, and the specified panoramic image is one of the panoramic images.

3. The method for automatic guide as claimed in claim 1, further comprising:
providing a space layout interface through the cloud server; and
setting a layout of a virtual space corresponding to the three-dimensional space model through the space layout interface to obtain the space layout data.

4. The method for automatic guide as claimed in claim 1, wherein the space layout data comprises a plurality of virtual objects corresponding to a plurality of exhibits, and each of the virtual objects has a corresponding configuration position and a positioning point.

5. The method for automatic guide as claimed in claim 1, further comprising:
in response to the user interface of the client apparatus communicatively connecting the cloud server, executing the real-time rendering program through the cloud server to embed a preset panoramic image corresponding to a preset position as a material to the three-dimensional space model; and
displaying the three-dimensional space model embedded with the preset panoramic image through the user interface,
wherein the three-dimensional space model comprises a plurality of positioning points, a database of the cloud server comprises a plurality of panoramic images respectively corresponding to the plurality of positioning points, the preset position is one of the positioning points, and the preset panoramic image is one of the panoramic images.

6. The method for automatic guide as claimed in claim 1, wherein the step of obtaining the response content corresponding to the input message from the space layout data through the cloud server comprises:
querying the space layout data of the three-dimensional space model through a large language model provided by the cloud server to obtain a query result corresponding to the input message; and
using the large language model by the cloud server to convert the query result into the response content conforming to a prompt engineering.

7. The method for automatic guide as claimed in claim 6, wherein when the response content comprises the description associated with the virtual object in the three-dimensional space model, the method for automatic guide comprises:
generating the recommended option associated with the virtual object through a front-end program provided by the cloud server, and outputting the response content and the recommended option to the user interface.

8. An automatic guide system comprising a cloud server and a client apparatus, wherein the client apparatus comprises a first storage device having a user interface, an input device, and a first processor, and the cloud server comprises a second processor, wherein
in the client apparatus, the first processor is configured to: communicatively connect the cloud server through the user interface, and display a three-dimensional space model provided by the cloud server in the user interface, wherein the three-dimensional space model has space layout data; and receive an input message through the input device, and transmit the input message to the cloud server through the user interface;
in the cloud server, the second processor is configured to: obtain response content corresponding to the input message from the space layout data, and determine whether the response content comprises a description associated with a virtual object in the three-dimensional space model; and when the response content comprises the description associated with the virtual object in the three-dimensional space model, output the response content and a recommended option associated with the virtual object to the user interface for display through the cloud server;
in the client apparatus, the first processor is configured to: when the recommended option is selected through the user interface, automatically send a control instruction to the cloud server through the user interface;
in the cloud server, the second processor is configured to: in response to receiving the control instruction, move a virtual camera corresponding to the three-dimensional space model to a specified positioning point corresponding to the virtual object and execute a real-time rendering program to embed a specified panoramic image corresponding to the specified positioning point as a material to the three-dimensional space model; and display the three-dimensional space model embedded with the specified panoramic image through the user interface.

9. A method for automatic guide using a processor to execute following steps:
displaying a three-dimensional space model through a user interface, wherein the three-dimensional space model has space layout data;
receiving an input message through an input device;
obtaining response content corresponding to the input message through the user interface, wherein the response content is generated based on the space layout data;
when the response content comprises a description associated with a virtual object in the three-dimensional space model, displaying the response content and a recommended option corresponding to the virtual object in the user interface;
when the recommended option is selected through the user interface, driving a virtual camera corresponding to the three-dimensional space model to move to a specified positioning point corresponding to the virtual object through the user interface and execute a real-time rendering program to embed a specified panoramic image corresponding to the specified positioning point as a material to the three-dimensional space model; and
displaying the three-dimensional space model embedded with the specified panoramic image through the user interface.
